(19) United States
(12) Patent Application Publication
(10) Pub. No.: US 2024/0013429 A1
(43) Pub. Date: Jan. 11, 2024

(54) METHOD AND APPARATUS FOR LOCATING PEOPLE INDOORS

(71) Applicant: I4X S.R.L., Bergamo (IT)

(72) Inventor: Roberto DA FORNO, Pozzale di Cadore (IT)

(73) Assignee: I4X S.R.L., Bergamo (IT)

(21) Appl. No.: 18/253,732

(22) PCT Filed: Nov. 18, 2021
(86) PCT No.: PCT/IT2021/050372

§ 371 Date: May 19, 2023

(30) Foreign Application Priority Data
Nov. 19, 2020 (IT) 102020000027819

(51) Int. Cl. G06T 7/70; G06V 10/764; G06V 20/00

(52) U.S. Cl. CPC G06T 7/70; G06V 10/764; G06V 20/36; G06V 2201/07; G06T 2207/20081; G06T 2207/20084

(57) ABSTRACT

The invention concerns a method for locating users in a determinate indoor environment by means of artificial intelligence, comprising the creation and storage of a data set of images associated with a position of acquisition in said environment, the training of at least one neural network of a processing unit in order to teach it to recognize and determine a relationship between image and position, and the processing of an image received from a user in order to recognize and identify the position of acquisition of the image.

### FIELD OF THE INVENTION

Embodiments described here concern a method and an apparatus for locating people indoors, or inside at least partly closed environments, which are based on artificial intelligence techniques.

### BACKGROUND OF THE INVENTION

Locating devices and apparatuses are known, for example associated with road maps, which can be used by a user to know and identify his own geographical position. In particular, software applications are known that can be installed on electronic devices such as smartphones, tablets or suchlike, based on GPS (Global Positioning Systems) technology, which receive data from orbiting satellites.

Although this technology is very effective for identifying an outdoor position, it is not so effective in closed environments, such as buildings, or underground environments, such as tunnels, or corridors of a subway, since on the one hand there are limits caused by the possible shielding of the GPS signal, and on the other hand limits given by the level of precision of the technology, which allows to identify the position in the range of a few meters.

In order to try to provide a user with an indication of his/her position in very large indoor environments, that is, which comprise a plurality of corridors or different areas, it is known to prepare, in determinate zones inside the environment itself, maps that can be consulted by the user to recognize the point where he/she is.

The maps generally show a plan of the building, on which a point is placed in correspondence with the zone where it is positioned, indicative of the position of a user present in the vicinity of the map.

One disadvantage of these solutions is that it is necessary to define the points in which to position the maps and then, for each point, to prepare the map with the correct position indicated.

Furthermore, since the maps are positioned only in determinate points, they are not always available to a user, who must therefore identify and reach them in order to obtain information correlated to his/her position. However, they could be distant from the position in which the user is located, and therefore could be inconvenient.

In fact, maps allow the user to know his/her position only in the vicinity of a map, and therefore only in a limited number of points inside the environment.

Other known solutions, generally adopted in parking lots, in particular underground ones, provide to divide the overall environment into areas each associated with a respective code, or name, in such a way that a user can identify the area in which he/she is located and, orienting him/herself between successive codes, can reach another destination area.

One disadvantage of these solutions is that the user is required to remember the code or name of a determinate area by heart, in order to orient him/herself in the parking lot, understand where he/she is and the direction in which he/she has to go, for example to recover his/her car.

Another disadvantage of the maps or signs known in the state of the art is that they cannot be used by blind or visually impaired people.

To try to solve these problems, indoor locating apparatuses are known, based on triangulation systems of radio signals, or laser signals. However, even these solutions require the installation of signal emitting or repeater devices in known positions.

Other known solutions provide to use artificial intelligence, to recognize determinate reference objects inside an image received from a user, and from these to trace the user's position. These solutions, however, require complex calculation algorithms and therefore a high computational burden in order to identify and recognize the reference objects in the image.

There is therefore a need to perfect an apparatus and a method for locating people in indoor environments that can overcome at least one of the disadvantages of the state of the art.

In particular, one purpose of the present invention is to provide a locating apparatus which is simple for a user to use, and which allows to obtain an indication of his/her position substantially in every point of the environment where the user is, even in unstructured environments, and without pre-installed devices for signal transmission/reception.

Another purpose of the present invention is to provide a locating apparatus which can also be used by blind people to determine their own position.

Another purpose of the present invention is to perfect a highly efficient method for locating people in indoor environments.

Another purpose is to provide an automatic locating method which requires a reduced computing capacity that can be implemented on a simple electronic device of a user.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, the present invention concerns a method for locating users in an indoor environment by means of artificial intelligence, which comprises the following steps:
creation and storage of a data set of images of a determinate environment, each uniquely associated with a respective label which defines a position of acquisition thereof;
training of a neural network of a processing unit on the basis of the stored data set of images;
reception of an image acquired by a user inside the environment;
processing of the image received by means of the neural network in order to recognize and identify, on the basis of the stored data set of images, the position corresponding with higher probability to the position of acquisition of the image received;
communication of the position identified to the user.

According to some embodiments, the creation and storage of the data set comprises the acquisition of a plurality of images according to a defined spatial frequency and the association of each image with a label defining the acquisition position data of the image itself.

In this way, in the data set the images are substantially classified on the basis of their position of acquisition, allowing to recreate a model of the environment considered in the form of two-dimensional images.

According to some embodiments, the method provides to acquire the images with a spatial frequency such that images acquired from successive positions of acquisition have at least one common portion.

According to some embodiments, the spatial frequency of acquisition of the images can be kept substantially constant over the entire space of the environment considered.

According to possible alternative solutions, it can be provided that the spatial frequency of acquisition of the images is varied, for example as a function of the zone inside the environment, and of what is present in that zone.

According to some embodiments, the method according to the invention provides to train the neural network by supplying at input a sequence of acquired images dependent on the position of acquisition, in order to teach the neural network to create an association between images and labels correlated to the position, to recognize, starting from an image received, the closest position correlated to the image on the basis of the data present in the memory.

In other words, based on the training received, the neural network supplies the position inside the environment that has the higher probability of being the position of acquisition of the image received.

Advantageously, in order to identify the position of acquisition of an image, the method provides to directly use the images received without proceeding with any prior processing thereof before supplying them to the neural network. In particular, neither the identification of geometric primitives nor the recognition of reference objects or data within the images is required, thus requiring a reduced computing capacity.

In this way, it is possible to obtain an indication of the user's position substantially in real time even with electronic devices that have a reduced computing capacity. The position processing, in fact, since it requires a reduced computational burden, can also be implemented on commonly used electronic devices, such as for example a smartphone or tablet, without taking up excessive memory space.

According to some embodiments, the method provides to supply to the user an indication of the position identified by means of the electronic device, in the format of a visual or sound signal.

In particular, it can be provided to supply an audio message, for example to indicate in which zone of the building the user is located, and what is in the area surrounding the position identified, such as the name of a shop inside a shopping center, the number of a room or a deck of a ship, or the type of items for sale in an isle of a supermarket, so as to make the locating also possible for visually impaired or blind users.

Some embodiments described here also concern an apparatus for locating a person in an indoor environment, comprising a memory unit in which at least one data set of images is stored, comprising a plurality of images of the environment, each associated with a label that identifies a position in which it has been acquired.

The locating apparatus also comprises a processing unit, for example a CPU, configured to process and classify the acquired images and the information correlated to the position of acquisition of the images.

According to one aspect of the present invention, the processing unit comprises at least one neural network trained to receive at input an image acquired by a user inside the environment correlated to the data set, determine an association between the image received and a position in which it has been acquired, and supply at output the position identified.

Here and hereafter in the description, with the expression “neural network” we mean a computing architecture in which a plurality of elementary processors are connected for the parallel processing of information, thus forming a network the structure of which resembles the structure of the human brain, in which there are a plurality of synapses.

According to some embodiments, in the data set the position is defined by a label associated with the image. This label can comprise an alphanumeric code, or a code of a different type, for example a string in binary, decimal, hexadecimal code, or other, explicitly and uniquely defining a specific position.

According to some embodiments, the position data can comprise both the indication of a point in space and also a possible orientation with respect to that point.

According to some embodiments, in the memory unit there is stored a set of “labelled” images, that is, each one correlated to, and associated with, one position, the set acting as a database for training the neural network.

In other words, the neural network can be trained by supplying it at input pairs of image-position associations, on the basis of which it elaborates a function that allows it to learn to recognize and determine image-position associations similar to those known, also for images of the came environment that differ from those received during training.

The locating apparatus also comprises an electronic device, provided with an image acquisition unit, and put in communication with the processing unit.

According to some embodiments, the processing unit and/or the memory unit can be implemented in the electronic device, or it/they can be implemented on a cloud type platform.

### BRIEF DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic view of a locating apparatus according to some embodiments described here;

FIG. 2 is a schematic view of a closed environment, in particular a supermarket provided with a plurality of shelving units and aisles;

FIGS. 2a-2d are respective images acquired in determinate positions inside the environment in FIG. 2;

FIG. 3 is an enlarged detail of FIG. 2;

FIGS. 3a-3d show images correlated to positions next to and subsequent to each other.

To facilitate comprehension, the same reference numbers have been used, where possible, to identify identical common elements in the drawings. It is understood that elements and characteristics of one embodiment can conveniently be combined or incorporated into other embodiments without further clarifications.

### DETAILED DESCRIPTION OF SOME EMBODIMENTS

We will now refer in detail to the possible embodiments of the invention, of which one or more examples are shown in the attached drawings by way of a non-limiting illustration. The phraseology and terminology used here is also for the purposes of providing non-limiting examples.

Some embodiments described here concern a locating apparatus 10, which can be used to allow a user to know his/her position inside an indoor environment 20.

By way of example, the locating apparatus 10 according to the invention can be used to allow a user to know his/her position inside an at least partly closed environment 20, such as for example a building, or a complex of buildings such as shopping centers, hospitals, school complexes, or even inside a supermarket, or medium/large ships, car parks, subways, tunnels or similar or comparable environments.

The locating apparatus 10 comprises a memory unit 11 in which at least one data set 12 of images 21 relating to a determinate environment 20 is stored, each image 21 being associated with a label 22 that identifies a position Pi of acquisition of the image 21.

The locating apparatus 10 also comprises a processing unit 13, for example a CPU, configured to process and classify the images 21 and the data relating to the position P of acquisition of the images 21.

According to some embodiments, the label 22 can comprise an alphanumeric code, or a code of a different type, for example a string in binary, decimal, or hexadecimal code, or other, explicitly and uniquely defining a specific position.

According to some embodiments, the position data can comprise both the indication of a point in space and also a possible orientation with respect to that point.

For example, the position Pi data can comprise an indication of the relative distance with respect to a wall 23, 24 or to an edge 25 between adjacent walls 23, 24 of an environment 20, which are considered as an absolute reference point.

According to other solutions, the position Pi data can comprise an indication of the geographical orientation with respect to such point, for example the cardinal points north, south, east, west, and any degrees of inclination with respect thereto.

According to other embodiments, the position Pi data can comprise information correlated to marks or indications included directly on the images during their acquisition.

According to some embodiments, the data set 12 comprises a sequence of images 21 acquired with a determinate spatial frequency F, selected in a suitable way in order to allow to identify the position of acquisition with a high degree of precision.

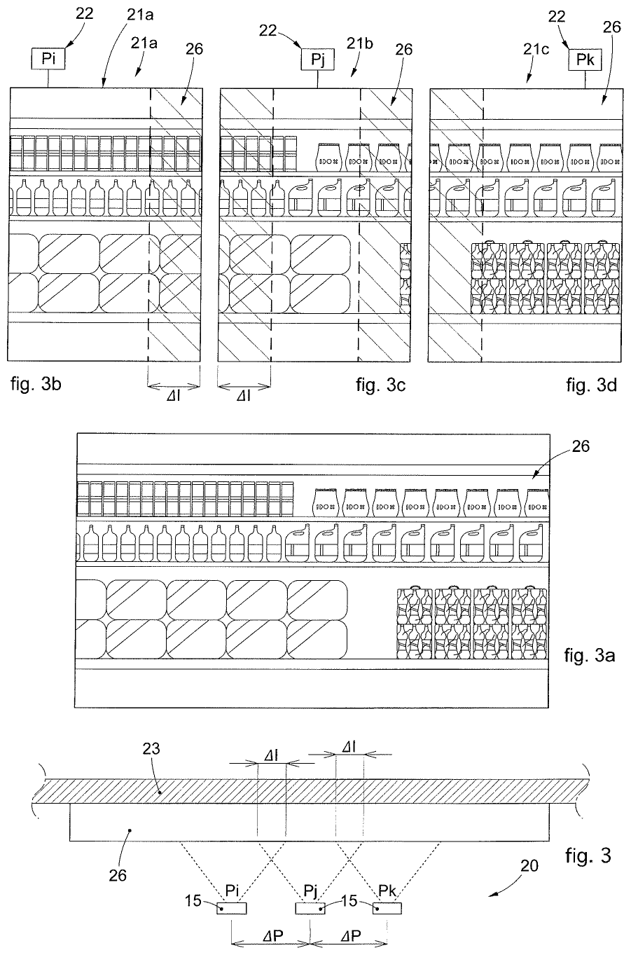

It can also be provided that the spatial interval ΔP between the position Pi of acquisition of two successive images 21 is such that the images share at least part of their content, that is, they can at least partly overlap with each other (FIG. 3).

It can also be provided to divide the environment 20 into a plurality of spaces, for example according to a grid, or a matrix, and acquire one or more images for each one of the spaces as a function of the spatial resolution to be achieved. The greater the number of images per square meter, the greater the resolution achievable. By way of example, the spatial interval ΔP between two successive points Pi, Pj, Pk of acquisition can be comprised between 100 cm and 200 cm.

The apparatus 10 can comprise an image acquisition device 30 such as a photo camera or a video camera, suitable to acquire images 21 in order to build the data set 12, connected to the processing unit 13.

The image acquisition device 30 and the processing unit 13 can be integrated into the same electronic device, or they can be defined by different devices connected to each other via cable or by means of wireless communication.

The image acquisition device 30 can be configured to acquire images 21 in the visible and/or infrared light frequency band.

At least one artificial intelligence algorithm is implemented in the processing unit 13. Preferably, at least the following are implemented: a learning algorithm based on Deep Learning for the recognition and determination of a relationship between image and position of acquisition, and a recognition algorithm based on Deep Learning for the determination and identification of the position of an image received.

By “Deep Learning” here and hereafter in the description we mean a set of techniques based on artificial neural networks organized in different layers, in which each layer calculates the values for the next one so that the processing is processed in a way that is increasingly complete.

According to some embodiments, any operating system whatsoever can be implemented on the processing unit 13, such as for example Android, iOS, Windows, Linux, or other.

The processing unit 13 comprises at least one neural network 14 which is trained to identify, on the basis of the acquired images 21 and the position P data stored in the data set 12, an association between an image I1, I2, I3 of the environment 20 received from a user and a position P1, P2, P3 of acquisition thereof inside the environment 20, correlated to the position of the user him/herself.

In other words, the data set 12 of “labelled” images, that is, each image being correlated and associated with a position Pi, serves as a database to train the neural network 14.

According to some embodiments, one or both of the learning and recognition algorithms are based on at least one neural network 14.

According to possible variants, one or both the algorithms are based on “transfer training”, that is, on a training transferred from structures of pre-existing neural networks.

The apparatus 10 also comprises at least one image acquisition unit 15 put in communication with the processing unit 12 by means of which a user can acquire an image I of the environment 20 surrounding his/her position and transmit it to the processing unit 13.

The image acquisition unit 15 can be configured to operate in the visible and/or infrared light frequency band.

The image acquisition unit 15 can be integrated into a user's electronic device 16, such as for example a smartphone, or a tablet, or it can be connected to an electronic device 16 by means of a cable or in wireless mode.

The electronic device 16 can be provided, in a known way, with a display screen 17 and a processing and control unit 18, such as a CPU or suchlike.

The processing unit 13 is configured to process the image I1, I2, I3 received from the image acquisition unit 15 and determine the position P1, P2, P3 in which the image was acquired, and communicate the determined position to the user, for example by means of the electronic device 16.

In particular, the processing unit 13 supplies at input to the neural network 14 the image I received and the neural network 14 determines, on the basis of the training received, that is, the learning algorithm, and of the stored data set correlated to the environment 20, the position that has the higher probability of being the one corresponding to the position of acquisition of the image I.

Here and hereafter in the description, with the expression “neural network” we mean a computing architecture provided with a plurality of elementary processors connected for the parallel processing of information, thus forming a network the structure of which resembles the structure of the synapses of the human brain.

According to some embodiments, the neural network 14 can be a convolutional neural network (CNN), preferably multilevel, comprising at least one input level, at least one intermediate level, and an output level.

The input level is the level that receives data from the outside, and comprises a number of nodes equal to the number of input variables, and the intermediate level receives a signal from the input level to supply a value to the output level on the basis of the input signal. An input signal can be multiplied by a determinate weight in each node or link, and the values obtained can be added together; when the sum exceeds a threshold value, the corresponding node is activated and can supply an output value.

The neural network 14, on the basis of the image-position associations that are supplied to it at input during the training step, learns to recognize the correlation between image and position and to determine the position of images that are similar to the known ones.

According to some embodiments, the convolutional neural network 14 can be of the type with supervised learning or with unsupervised learning.

The data set 12 of images 21 thus allows to map and recreate in terms of two-dimensional images a determinate closed environment 20, such as for example a supermarket, a shopping center, the inside of a ship, a building or school complex, a parking area.

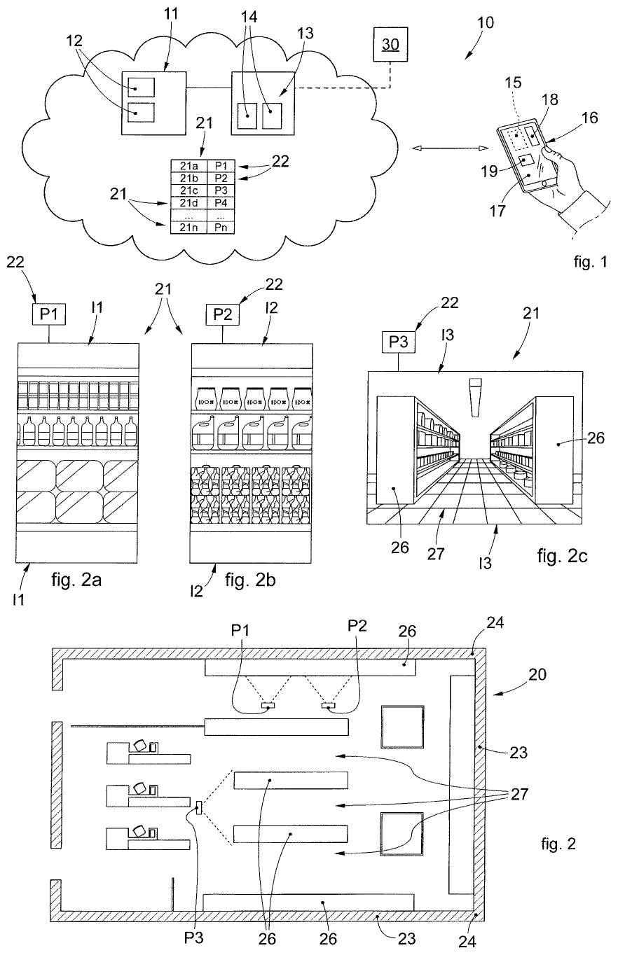

FIGS. 2 and 2a-2c show by way of example a top view of an indoor environment, in this specific case a supermarket 20, in which there is a plurality of shelves, each suitable to contain a determinate type of products, and a plurality of shelves 26 that delimit respective aisles 27.

A plurality of articles of different types are positioned on each of the shelves 26.

When the user is in any position P1, P2, P3 inside the environment 20, he/she can acquire an image I1, I2, I3 of what he/she sees and transmit it to the processing unit 13.

This will transmit the image received to the neural network 14 which will supply at output the position P1, P2, P3 which on the basis of the learning algorithm has the higher probability of being the position of acquisition of the image received.

This information will then be transmitted by the processing unit 13 to the user by means of the electronic device 16.

According to some embodiments, the processing unit 13 and/or the memory unit 11 can be implemented in the electronic device 16, directly in its processing and control unit 18.

According to possible variants, for example shown in FIG. 1, one or more of the memory unit 11 and the processing unit 13 can be stored and installed remotely, for example on a cloud type IT platform.

In this case, a software application can be implemented on the electronic device 16 by means of which it can communicate with the platform in order to transmit the acquired image to it and receive the indication of the position.

The electronic device 16 can be provided with means for receiving and transmitting an audio signal, for example earphones and/or a loudspeaker.

Some embodiments described here concern a method for locating users in an indoor environment by means of artificial intelligence, which comprises the following steps:
creation and storage of a data set 12 of images 21 of a determinate environment 20, each uniquely associated with a respective label 22 which defines a position P of acquisition thereof;
training of at least one neural network 14 of the processing unit 13 by supplying at input to the neural network 14 the associations of images 21 and labels 22 of the stored data set 12 in order to teach the neural network 14 to recognize and determine a relationship between image 21 and respective position P of acquisition;
reception of an image 21 acquired by a user inside the environment 20;
processing of the image 21 received by means of the neural network 14 in order to recognize and identify, on the basis of the stored data set 12 of images, a position corresponding with higher probability to the position P of acquisition of the image 21 received;
communication of the position identified to the user.

According to some embodiments, the creation and storage of the data set 12 comprises the acquisition of a plurality of images 21 with the image acquisition device 30 according to a defined spatial frequency F, and the association of each image 21 with a label 22 defining the acquisition position P data of the image 21 itself.

By way of example, FIG. 3a shows a front view of the shelf 26 of FIG. 3, while FIGS. 3b-3d show three images 21a, 21b, 21c respectively acquired in positions Pi, Pj and Pk.

The spatial interval ΔP between respective adjacent positions Pi−Pj, Pj−Pk, that is, the spatial frequency F=1/ΔP can be at a constant value or variable inside the environment 20 itself.

According to some embodiments, the spatial frequency F of acquisition of the images can be kept substantially constant in the entire space of the environment considered.

According to possible alternative solutions, it can be provided that the spatial frequency F is varied, for example as a function of specific zones inside the environment 20 and of what is present in such zones. For example, a higher spatial frequency F can be provided in the zones with a higher density of visual information or with a greater variability thereof, and a lower spatial frequency F can be provided for the zones that have uniformity or homogeneity of visual information.

According to some embodiments, the method provides to acquire the images 21 with a spatial frequency F such that images 21 acquired from successive positions P of acquisition have at least one common portion AI.

During the creation of the data set 12, each image 21a, 21b, 21c will be associated with the respective position Pi, Pj, Pk in which they were acquired.

According to some embodiments, the step of training the neural network 14 provides to use supervised learning techniques, that is, to instruct the neural network 14 in such a way as to allow it to autonomously process predictions on the output values with respect to a datum supplied at input on the basis of ideal examples consisting of pairs of input and output data, in the present case defined by the associations of images 21 and positions P.

The neural network 14, on the basis of the associations supplied during the training step, can therefore learn the correct correlation between image 21 and position P in which the image was acquired, and process a mathematical function that allows it to approach the desired results for the examples not supplied, that is, for any position whatsoever inside the mapped environment 20.

When the processing unit 13 receives an image I1, I2, I3 acquired by the user, the neural network 14 trained by means of the data set 12 can therefore supply to the user, substantially in real time, the position P1, P2, P3 in which he/she is located.

In particular, in order to identify the position of acquisition of an image I1, I2, I3 received, the method provides to directly use the image I1, I2, I3 received, without proceeding with any prior processing thereof before supplying it to the neural network 14. In particular, neither the identification of the geometric primitives nor the recognition of reference objects or data within the images is required, thus requiring a reduced computing capacity.

This allows to obtain at output an indication of the position P1, P2, P3 substantially in real time.

According to some embodiments, the method provides to supply to the user an indication of the position P1, P2, P3 identified by means of the electronic device 16, in the format of a visual or sound signal.

In particular, it can be provided to supply an audio message, for example to indicate in which zone of the building the user is located, and what is in the area surrounding the position identified, such as the name of a shop inside a shopping center, the number of a room or a deck of a ship, or the type of items for sale in an isle of a supermarket, so as to make the locating also possible for visually impaired or blind users.

It is clear that modifications and/or additions of parts or steps may be made to the locating apparatus 10 and method as described heretofore, without departing from the field and scope of the present invention as defined by the claims.

In the following claims, the sole purpose of the references in brackets is to facilitate reading: they must not be considered as restrictive factors with regard to the field of protection claimed in the specific claims.

1. Method for locating users in a determinate indoor environment by means of artificial intelligence, comprising:
creation and storage of a data set of images, each uniquely associated with a respective label which defines a position of acquisition thereof in said environment;
training of at least one neural network of a processing unit which, at input, is supplied with associations of images and labels of said stored data set, in order to teach it to recognize and determine a relationship between image and position;
reception of an image acquired by a user by means of an image acquisition unit inside said environment;
processing of the image received by means of said at least one neural network in order to recognize and identify, on the basis of said stored data set, the position corresponding with higher probability to the position of acquisition;
communication of said position identified to the user.

2. Locating method as in claim 1, wherein said creation and storage of said data set comprises the acquisition of a plurality of images according to a defined spatial frequency-EH, and the association of each image with a label defining the image acquisition position data in order to recreate a model of said environment considered in the form of two-dimensional images.

3. Method as in claim 1, further comprising using a neural network of the convolutional multi-level type, and supplying at input to said neural network the image directly as acquired by said image acquisition unit.

4. Method as in claim 1, wherein in order to train said neural network, the method further comprises using supervised learning techniques.

5. Method as in claim 1, wherein in order to train said neural network, the method further comprises using unsupervised learning techniques.

6. Method as in claim 1, further comprising communicating to said user the position identified by means of an electronic device connected to, or integrated with, said image acquisition unit by means of a visual or audio signal.

7. Apparatus for locating a user in an indoor environment, comprising:
a memory unit in which at least one data set of images is stored, comprising a plurality of images, each one associated with a label which identifies a position in which said image has been acquired in said environment;
a processing unit configured to process and classify said acquired images and the information correlated to said position, which comprises at least one neural network trained to recognize and determine a relationship between image and position on the basis of said data set, and configured to receive at input an image and identify a position corresponding with higher probability to said position of acquisition;
an image acquisition unit put in communication with said processing unit, said image acquisition unit being configured to acquire an image of the surroundings of the position in which said user is located and transmit it to said processing unit;
an electronic device associated with said user, connected to, or integrated with, said image acquisition unit, configured to receive a communication from said processing unit regarding said position identified.

8. Apparatus as in claim 7, wherein said electronic device is a smartphone or tablet, and at least one of either said memory unit or said processing unit is locally installed in said electronic device.

9. Apparatus as in claim 7, wherein said electronic device is a smartphone or tablet, and at least one of either said memory unit or said processing unit is remotely stored on a computer platform, and a software application is implemented on said electronic device by means of which it communicates with said platform.

10. Apparatus as in claim 7, wherein said at least one neural network is a convolutional neural network (CNN).
